(19) United States
(12) Patent Application Publication
(10) Pub. No.: US 2021/0301165 A1
(43) Pub. Date: Sep. 30, 2021

(54) Aqueous Ink Jet Composition, Ink Set, Ink Jet Recording Apparatus, And Method For Manufacturing Recorded Matter

(71) Applicant: Seiko Epson Corporation, Tokyo (JP)

(72) Inventors: Soichi YAMAZAKI, Shiojiri (JP); Manabu TANIGUCHI, Shiojiri (JP); Hiroaki KUMETA, Matsumoto (JP); Shunsuke UCHIZONO, Shiojiri (JP); Naoyuki TOYODA, Suwa (JP)

(21) Appl. No.: 17/210,687

(22) Filed: Mar. 24, 2021

(30) Foreign Application Priority Data
Mar. 25, 2020 (JP) 2020-054106
Mar. 26, 2020 (JP) 2020-055568

(51) Int. Cl. C09D 11/322; C09D 11/38; C09D 11/104; C08K 5/3415; C08K 5/17; C09B 47/04; B41J 11/00

(52) U.S. Cl. CPC C09D 11/322; C09D 11/38; C09D 11/104; B41J 11/002; C08K 5/175; C09B 47/04; C08K 5/3415

(57) ABSTRACT

An aqueous ink jet composition includes a dye component composed of at least one of sublimation dyes and disperse dyes, polyester, 1-(hydroxyalkyl)-2-pyrrolidone, and water, wherein the content (mass %) of the polyester is 4.0 times or more and 300.0 times or less the content (mass %) of the dye component.

The present application is based on, and claims priority from JP Application Serial Number 2020-055568, filed Mar. 26, 2020 and JP Application Serial Number 2020-054106, filed Mar. 25, 2020, the disclosures of which are hereby incorporated by reference herein in their entirety.

### BACKGROUND

### 1. Technical Field

The present disclosure relates to an aqueous ink jet composition, an ink set, an ink jet recording apparatus, and a method for manufacturing a recorded matter.

### 2. Related Art

An ink jet method is tried to be applied to not only recording images on recording media but also printing on fabrics, and a variety of ink compositions for ink jet printing have been studied. An aqueous ink jet composition for printing contains a coloring material for obtaining an image having desired color, and as the color material, a dye or a pigment is used. In addition, an aqueous ink jet composition for printing is also required to have the same or better performance as a normal aqueous ink jet composition.

For example, as an aqueous ink jet composition, a composition containing a dye having sublimability has also been studied. JP-A-10-58638 discloses a sublimation transfer printing method by producing a sublimation transfer printing original plate by jetting an ink in which fine particles containing a sublimation dye are dispersed with an ink jet head, heating an arbitrary print medium and the sublimation transfer original plate in a laid-over state, and transferring the sublimation dye to the print medium through thermal diffusion and/or thermal sublimation.

In addition, recently, an ink jet recording system using a pigment ink containing a pigment as a color material has spread. When a pigment ink is discharged to a recording medium, since the pigment is placed on the surface of the recording medium and does not penetrate into the inside, a clear image can be recorded.

For example, JP-A-2014-70126 discloses an ink jet recording ink containing water, a pigment, a penetrant, and trimethylglycine. In addition, this patent literature describes that the purpose of adding trimethylglycine to the ink is improvement of the storage stability of the ink and prevention of bleeding on the receiving paper.

However, in the ink using an organic solvent disclosed in JP-A-10-58638, precipitation, solidification, or the like of the color material is caused depending on the organic solvent used in combination or formulation. For example, clogging recovery is insufficient in some cases. In addition, many performances required for ink are difficult to control independently of each other by formulation, accordingly, for example, even if the dye concentration and the organic solvent type and amount are variously studied in order to improve the clogging recovery, performances including the color development property are reduced in many cases. In an aqueous ink jet composition, it is required to achieve both clogging recovery and color development property.

In addition, in the ink described in JP-A-2014-70126, it is difficult to prevent generation of a solid content derived from a pigment by dry solidification. If this solid content occurs near a nozzle, the solid content cannot be re-dispersed even if subsequent ink arrives, and permanent nozzle omission that is never recovered occurs in some cases.

### SUMMARY

An aspect of the aqueous ink jet composition according to the present disclosure includes a dye component composed of at least one of sublimation dyes and disperse dyes, polyester, 1-(hydroxyalkyl)-2-pyrrolidone, and water, in which the content (mass %) of the polyester is 4.0 times or more and 300.0 times or less the content (mass %) of the dye component.

An aspect of the method for manufacturing a recorded matter according to the present disclosure includes an imparting step of discharging the aqueous ink jet composition of the above aspect by an ink jet method to impart the composition to a recording medium and a heating step of heating the recording medium imparted with the aqueous ink jet composition.

An aspect of the aqueous ink jet ink composition according to the present disclosure contains a pigment, 1-(2-hydroxyalkyl)-2-pyrrolidone, trimethylglycine, and an organic amine, wherein the pigment, the 1-(2-hydroxyalkyl)-2-pyrrolidone, and the trimethylglycine in the aqueous ink jet ink composition have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine.

An aspect of the ink set according to the present disclosure includes a first ink and a second ink different from the first ink in color, wherein the first ink and the second ink each contain a pigment, 1-(2-hydroxyalkyl)-2-pyrrolidone, trimethylglycine, and an organic amine, and the pigment, the 1-(2-hydroxyalkyl)-2-pyrrolidone, and the trimethylglycine in each of the first ink and the second ink have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine.

An aspect of the ink jet recording apparatus according to the present disclosure, in which a single head cap seals two or more inks each containing a pigment, 1-(2-hydroxyalkyl)-2-pyrrolidone, trimethylglycine, and an organic amine, and the pigment, the 1-(2-hydroxyalkyl)-2-pyrrolidone, and the trimethylglycine in each of the two or more inks have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine.

### BRIEF DESCRIPTION OF THE DRAWING

FIG. 1s a sectional side view schematically illustrating the structure of an ink jet recording apparatus according to an embodiment.

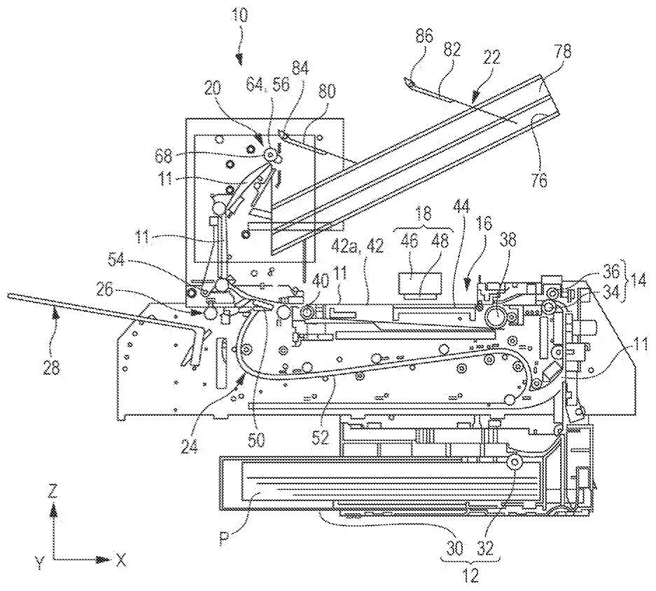

### DESCRIPTION OF EXEMPLARY EMBODIMENTS

Embodiments of the present disclosure will now be described. The embodiments described below describe examples of the present disclosure. The present disclosure is not limited to the following embodiments and includes various modifications that are implemented within a range not changing the gist of the present disclosure. It should be noted that not all of the configurations described below are essential configurations of the present disclosure.

### 1. AQUEOUS INK JET COMPOSITION

An aqueous ink jet composition of the present embodiment includes a dye component composed of at least one of sublimation dyes and disperse dyes, polyester, 1-(hydroxyalkyl)-2-pyrrolidone, and water. The content (mass %) of the polyester is 4.0 times or more and 300.0 times or less the content (mass %) of the dye component.

### 1.1. Dye

The aqueous ink jet composition includes a dye component composed of at least one of sublimation dyes and disperse dyes. In the following explanation, the dye component composed of at least one of sublimation dyes and disperse dyes may be referred to as “specific dye”. In addition, among the disperse dyes, sublimation type disperse dyes and easily sublimating disperse dyes are also referred to as sublimation dyes.

The specific dye generally exhibits an excellent color development property for polyester. As the specific dye, dyes of each color shown below can be used.

Yellow sublimation dye and disperse dye are not particular limited, and examples thereof include C.I. Disperse Yellow 1, 3, 4, 5, 7, 9, 13, 23, 24, 30, 33, 34, 42, 44, 49, 50, 51, 54, 56, 58, 60, 61, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 154, 160, 162, 163, 164, 165, 179, 180, 182, 183, 184, 186, 192, 198, 199, 201, 202, 204, 210, 211, 215, 216, 218, 224, 227, 231, and 232.

Orange sublimation dye and disperse dye are not particularly limited, and examples thereof include C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 60, 61, 66, 71, 73, 76, 78, 80, 89, 90, 91, 93, 96, 97, 119, 127, 130, 139, and 142.

Red sublimation dye and disperse dye are not particularly limited, and examples thereof include C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328, and 364.

Violet sublimation dye and disperse dye are not particularly limited, and examples thereof include C.I. Disperse Violet 1, 4, 8, 23, 26, 27, 28, 31, 33, 35, 36, 38, 40, 43, 46, 48, 50, 51, 52, 56, 57, 59, 61, 63, 69, and 77.

Green sublimation dye and disperse dye are not particularly limited, and examples thereof include C.I. Disperse Green 9.

Brown sublimation dye and disperse dye are not particularly limited, and examples thereof include C.I. Disperse Brown 1, 2, 4, 9, 13, and 19.

Blue sublimation dye and disperse dye are not particularly limited, and examples thereof include C.I. Disperse Blue 3, 7, 9, 14, 16, 19, 20, 24, 26, 27, 35, 43, 44, 54, 55, 56, 58, 60, 62, 64, 71, 72, 73, 75, 79, 81, 82, 83, 87, 91, 92, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 191, 197, 198, 200, 201, 205, 207, 211, 214, 224, 225, 257, 259, 267, 268, 270, 284, 285, 287, 288, 291, 293, 295, 297, 301, 315, 330, 333, 359, and 360.

Black sublimation dye and disperse dye are not particularly limited, and examples thereof include C.I. Disperse Black 1, 3, 10, and 24.

As the specific dye, the above-mentioned sublimation dyes and disperse dyes may be used singly or in combination of two or more.

In particular, the specific dye may be composed of one or more selected from the group consisting of C.I. Disperse Yellow 154, C.I. Disperse Red 60, C.I. Disperse Red 364, and C.I. Disperse Blue 191. Consequently, the color development property of the colored portion of a recorded matter can be made more excellent. In addition, it is possible to secure a sufficient color development property even in heating treatment at a lower temperature for a shorter time.

The specific dye can be stably dispersed in the aqueous ink jet composition and may be used, for example, as a self-dispersible color material by oxidizing the color material surface with ozone, hypochlorous acid, fuming sulfuric acid, or the like or by modifying the surfaces of color material particles through sulfonation or may be used by being dispersed by a known dispersant.

The lower limit of the content of the specific dye in the aqueous ink jet composition can be 0.1 mass % and may be 0.15 mass % or 0.2 mass %. In addition, the upper limit of the content of the specific dye in the aqueous ink jet composition can be 7.5 mass % and may be 3.0 mass % or 2.4 mass %.

The aqueous ink jet composition of the present embodiment may contain another color material (additional color material) as needed in addition to the specific dye. Examples of the additional color material include water-soluble dyes and pigments that are used in general ink compositions. When an additional color material is used, the amount of the additional color material based on the total amount of the aqueous ink jet composition can be 5.0 mass % or less and may be 1.0 mass % or less or 0.1 mass % or less. In addition, it is not necessary to use the additional color material.

### 1.2. Polyester

The aqueous ink jet composition of the present embodiment includes polyester. In general, the polyester is suitably dyed with the above-mentioned specific dye.

The polyester constituting the aqueous ink jet composition may be any polymer material that has an ester bond in the main chain and, for example, may be unmodified polyester or modified polyester.

Examples of commercially available polyester that can be used in the aqueous ink jet composition include Polyester manufactured by The Nippon Synthetic Chemical Industry Co., Ltd., Plas Coat (registered trademark) manufactured by Goo Chemical Co., Ltd., Aron Melt (registered trademark) manufactured by Toagosei Co., Ltd., ELITEL (registered trademark) manufactured by Unitika Ltd., PESRESIN (registered trademark) manufactured by Takamatsu Oil & Fat Co., Ltd., SUPERFLEX (registered trademark) manufactured by DKS Co., Ltd., VYLONAL (registered trademark) manufactured by TOYOBO Co., Ltd., and Nipolon (registered trademark) which is polyester polyol manufactured by TOSOH Corporation. When a product that is put on the market as a polyester water dispersion is used, the content of the polyester is adjusted such that the content of the polyester as a solid content has the above-mentioned relationship.

The lower limit of acid value of the polyester can be 1.0 KOH mg/g and may be 1.5 KOH mg/g or 2.0 KOH mg/g. In addition, the upper limit of acid value of the polyester constituting the aqueous ink jet composition can be 15 KOH mg/g and may be 10 KOH mg/g or 5.0 KOH mg/g. Consequently, the color development property of the specific dye in various recording media can be made more excellent.

The lower limit of hydroxyl value of the polyester can be 1.0 KOH mg/g and may be 2.0 KOH mg/g or 3.0 KOH mg/g. In addition, the upper limit of hydroxyl value of the polyester constituting the aqueous ink jet composition can be 20.0 KOH mg/g and may be 15.0 KOH mg/g or 10.0 KOH mg/g. Consequently, the color development property of the specific dye in various recording media can be made more excellent.

The lower limit of number average molecular weight of the polyester can be 3000 and may be 6000 or 10000. In addition, the upper limit of number average molecular weight of the polyester constituting the aqueous ink jet composition can be 25000 and may be 20000 or 18000. Consequently, the color development property of the specific dye in various recording media can be made more excellent.

The polyester in the aqueous ink jet composition may be in any form. For example, the polyester may be contained in a dissolution state in the aqueous ink jet composition or may be contained in a dispersion state such as a colloid state or an emulsion state. Alternatively, the polyester may be contained in a gelled state. In addition, the polyester may coat at least a part of the surface of the specific dye in the aqueous ink jet composition. Furthermore, these states may be mixed.

The polyester may be contained as particles dispersed in the aqueous ink jet composition. In such a case, the lower limit of volume average particle diameter of the polyester particle can be 20.0 nm and may be 40.0 nm or 60.0 nm. In addition, the upper limit of volume average particle diameter of the polyester can be 300.0 nm and may be 250.0 nm or 200.0 nm.

Consequently, the aqueous ink jet composition can be easily prepared, and the dispersion stability of the polyester in the aqueous ink jet composition, the storage stability of the aqueous ink jet composition, and the discharge stability and the clogging recovery of the aqueous ink jet composition by an ink jet method can be made more excellent.

Incidentally, in the present specification, the term “volume average particle diameter” refers to an average particle diameter based on volume. The volume average particle diameter can be determined by measurement using, for example, Microtrac UPA (manufactured by Nikkiso Co., Ltd.).

The lower limit of content of the polyester in the aqueous ink jet composition can be 2.0 mass % and may be 5.0 mass % or 10.0 mass %. In addition, the upper limit of content of the polyester in the aqueous ink jet composition can be 40.0 mass % and may be 30.0 mass % or 20.0 mass %.

Consequently, the storage stability of the aqueous ink jet composition and the discharge stability and the clogging recovery of the aqueous ink jet composition by an ink jet method can be made more excellent. In addition, the color development property of the specific dye and the optical concentration of the colored portion can be made more excellent.

1.3. 1-(Hydroxyalkyl)-2-pyrrolidone

1-(Hydroxyalkyl)-2-pyrrolidone is a compound in which a hydroxyalkyl group is bound to the 1-position of 2-pyrrolidone. Examples of the alkyl group thereof include a methyl group, an ethyl group, an n-propyl group, an i-propyl group, an n-butyl group, a sec-butyl group, an iso-butyl group, a tert-butyl group, various pentyl groups, and various hexyl groups.

The hydroxyalkyl group is a group in which one or more hydrogen atoms of the alkyl group are substituted with hydroxyl groups. The number of the hydroxyl groups is arbitrary and may be one or two and may be one. Furthermore, the carbon of the alkyl group to which a hydroxyl group binds may be carbon that does not bind to the 2-pyrrolidone and may be carbon (carbon at the beta-position) binding to the carbon that binds to the 2-pyrrolidone.

Examples of the 1-(hydroxyalkyl)-2-pyrrolidone include 1-(2-hydroxyethyl)-2-pyrrolidone, 1-(2-hydroxypropyl)-2-pyrrolidone, 1-(3-hydroxypropyl)-2-pyrrolidone, 1-(2,3-dihydroxypropyl)-2-pyrrolidone, 1-(2-hydroxy-i-propyl)-2-pyrrolidone, 1-(2-hydroxy-n-butyl)-2-pyrrolidone, 1-(3,4-dihydroxy-n-butyl)-2-pyrrolidone, 1-(2,3-dihydroxy-n-butyl)-2-pyrrolidone, and 1-(2-hydroxy-t-butyl)-2-pyrrolidone.

Incidentally, for example, 1-(2-hydroxyethyl)-2-pyrrolidone is also called by another name, such as N-hydroxyethylpyrrolidone or 1-(2-hydroxyethyl)pyrrolidin-2-one.

The 1-(hydroxyalkyl)-2-pyrrolidone is contained in the aqueous ink jet composition of the present embodiment as an organic solvent. 1-(Hydroxyalkyl)-2-pyrrolidone includes a hydroxyl group and therefore has high hydrophilicity compared to other organic solvents. Accordingly, the aqueous ink jet composition containing the 1-(hydroxyalkyl)-2-pyrrolidone can enhance the dispersibility of the specific dye therein and can prevent aggregation and solidification from occurring. When the aggregation and solidification of the specific dye are unlikely to occur, the clogging recovery of the aqueous ink jet composition can be made excellent. In addition, this effect is particularly significant when the concentration of the specific dye in the aqueous ink jet composition is high.

The content of the 1-(hydroxyalkyl)-2-pyrrolidone can be 0.5 mass % or more and 10.0 mass % or less based on the total amount of the aqueous ink jet composition and may be 1.0 mass % or more and 5.0 mass % or less or 1.0 mass % or more and 4.0 mass % or less.

### 1.4. Water

The aqueous ink jet composition according to the present embodiment contains water. Examples of the water include water with low ionic impurities, for example, pure water, such as ion-exchanged water, ultrafiltered water, reverse osmosis water, and distilled water, and ultrapure water. In addition, the use of water sterilized by, for example, UV irradiation or addition of hydrogen peroxide can suppress the outbreak of bacteria and fungi when the aqueous ink jet composition is stored for a long time.

The content of water can be 30 mass % or more based on the total amount of the aqueous ink jet composition and may be 40 mass % or more, 45 mass % or more, or 50 mass % or more. The term water in the aqueous ink jet composition includes, for example, the water contained in raw materials and the water to be added. When the content of water is 30 mass % or more, the aqueous ink jet composition can have a relatively low viscosity. In addition, the upper limit of the content of water can be 90 mass % or less based on the total amount of the aqueous ink jet composition and may be 85 mass % or less or 80 mass % or less.

### 1.5. Content Ratio Between Polyester and Dye

The content (mass %) of the polyester in the aqueous ink jet composition of the present embodiment is 4.0 times or more and 300.0 times or less the content (mass %) of the specific dye. When the content of the polyester and the content of the specific dye are controlled within this range, the printing of the polyester and printing on a polyester fabric can be efficiently performed.

The content (mass %) of the polyester in the aqueous ink jet composition can be 5.0 times or more and 250.0 times or less the content (mass %) of the specific dye and may be 6.0 times or more and 200.0 times or less or 10.0 times or more and 150.0 times or less.

### 1.6. Other Component

### 1.6.1. Solvent

The aqueous ink jet composition may contain a solvent other than water.

Consequently, the viscosity of the aqueous ink jet composition can be suitably adjusted, or the moisture retaining property of the aqueous ink jet composition can be increased. As a result, droplet discharge by an ink jet method can be more stably performed.

Examples of the solvent other than water contained in the aqueous ink jet composition include alkyl polyol, glycol ether, and cyclic amide.

Examples of the alkyl polyol include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, diethylene glycol, propylene glycol, dipropylene glycol, triethylene glycol, and glycerin. These alkyl polyols may be used singly or in combination of two or more.

The glycol ether is, for example, monoalkyl ether or dialkyl ether of glycol selected from the group consisting of ethylene glycol, diethylene glycol, triethylene glycol, polyethylene glycol, propylene glycol, dipropylene glycol, tripropylene glycol, polypropylene glycol, and polyoxyethylene polyoxypropylene glycol. More specifically, examples of the glycol ether include methyl triglycol (triethylene glycol monomethyl ether), butyl triglycol (triethylene glycol monobutyl ether), butyl diglycol (diethylene glycol monobutyl ether), and dipropylene glycol monopropyl ether. A typical example is diethylene glycol monobutyl ether.

Examples of the cyclic amide include γ-lactams, such as 2-pyrrolidone, 1-methyl-2-pyrrolidone (N-methyl-2-pyrrolidone), 1-ethyl-2-pyrrolidone (N-ethyl-2-pyrrolidone), 1-propyl-2-pyrrolidone, and 1-butyl-2-pyrrolidone, β-lactams, δ-lactams, and ε-lactams, such as ε-caprolactam. These cyclic amides may be used singly or in combination of two or more.

The aqueous ink jet composition may further contain an additional organic solvent. Examples of the additional organic solvent include lactones, such as γ-butyrolactone, and betaine compounds.

### 1.6.2. Other Materials

The aqueous ink jet composition of the present embodiment may contain a surfactant, a resin particle, a pH adjuster, a chelating agent, ureas, a preservative, a fungicide, a corrosion inhibitor, saccharides, and other additives, as materials in addition to the above-mentioned materials.

### Surfactant

The aqueous ink jet composition according to the present embodiment may include a surfactant. The surfactant can be used for reducing the surface tension of the aqueous ink jet composition to adjust or improve the wettability to a recording medium, for example, permeability to a fabric or the like. As the surfactant, any of nonionic surfactants, anionic surfactants, cationic surfactants, and amphoteric surfactants can be used, and a combination thereof may be used. In particular, among these surfactants, an acetylene glycol surfactant, a silicone surfactant, or a fluorine surfactant can be used.

The acetylene glycol surfactant is not particularly limited, and examples thereof include Surfynol series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (trade names, manufactured by Air Products and Chemicals, Inc.), Olfine series B, Y, P, A, STG, SPC, E1004, E1010, PD-001, PD-002W, PD-003, PD-004, PD-005, EXP.4001, EXP.4036, EXP.4051, AF-103, AF-104, AK-02, SK-14, and AE-3 (trade names, manufactured by Nissin Chemical Co., Ltd.), and Acetylenol series E00, E00P, E40, and E100 (trade names, manufactured by Kawaken Fine Chemicals Co., Ltd.).

Although the silicone surfactant is not particularly limited, a polysiloxane compound may be used. The polysiloxane compound is not particularly limited, and, for example, polyether modified organosiloxane is mentioned. As the commercial products of the polyether modified organosiloxane, for example, BYK-306, BYK-307, BYK-333, BYK-341, BYK-345, BYK-346, and BYK-348 (trade names, manufactured by BYK) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.) are mentioned.

As the fluorine surfactant, a fluorine modified polymer may be used, and examples thereof include BYK-340 (trade name, manufactured by BYK Chemie Japan K.K.).

When surfactants are mixed with an aqueous ink jet composition, the total amount of the surfactants can be 0.01 mass % or more and 3 mass % or less based on the total amount of the aqueous ink jet composition and may be 0.05 mass % or more and 2 mass % or less, 0.1 mass % or more and 1.5 mass % or less, or 0.2 mass % or more and 1 mass % or less.

In addition, the aqueous ink jet composition containing a surfactant tends to increase the stability when an ink is discharged from a head.

### Resin Particle

The aqueous ink jet composition may contain a resin particle in addition to the above-described polyester. Examples of the resin particle include resin particles made of a urethane resin, an acrylic resin (including a styrene acrylic resin), a fluorene resin, a polyolefin resin, a rosin modified resin, a terpene resin, a polyamide resin, an epoxy resin, a vinyl chloride resin, a vinyl chloride-vinyl acetate copolymer, or an ethylene vinyl acetate resin. In particular, a urethane resin, an acrylic resin, or a polyolefin resin may be used. These resin particles are often handled in emulsion form, but may have properties of powder. The resin particles may be one type of particle or a combination of two or more types of particles.

The urethane resin is a generic name of resins having a urethane bond. As the urethane resin, for example, a polyether urethane resin having an ether bond in the main chain in addition to the urethane bond, a polyester urethane resin having an ester bond in the main chain in addition to the urethane bond, or a polycarbonate urethane resin having a carbonate bond in the main chain in addition to the urethane bond may be used. In addition, as the urethane resin, a commercial product may be used. For example, SUPERFLEX series 460, 460s, 840, and E-4000 (trade names, manufactured by DKS Co., Ltd.), RESAMINE series D-1060, D-2020, D-4080, D-4200, D-6300, and D-6455 (trade names, manufactured by Dainichiseika Color & Chemicals Mfg. Co., Ltd.), Takelac series WS-5100, WS-6021, and W-512-A-6 (trade names, manufactured by Mitsui Chemicals Polyurethanes, Inc.), Sancure 2710 (trade name, manufactured by The Lubrizol Corporation), and PERMARIN UA-150 (trade name, manufactured by Sanyo Chemical Industries, Ltd.) may be used.

The acrylic resin is a generic name of polymers obtained by polymerizing at least an acrylic monomer, such as (meth)acrylic acid or (meth)acrylic ester, as one component, and examples thereof include a resin obtained from an acrylic monomer and a copolymer of an acrylic monomer and another monomer. For example, an acrylic vinyl resin, which is a copolymer of an acrylic monomer and a vinyl monomer, is mentioned. In addition, for example, styrene is mentioned as the vinyl monomer.

As the acrylic monomer, for example, acryl amide and acrylonitrile can also be used. The resin emulsion using an acrylic resin as a raw material may be a commercial product and may be selected from, for example, FK-854 (trade name, manufactured by Chuo Rika Kogyo Corporation), Movinyl series 952B and 718A (trade names, manufactured by The Nippon Synthetic Chemical Industry Co., Ltd.), and Nipol series LX852 and LX874 (trade names, manufactured by Zeon Corporation).

Incidentally, in the present specification, the acrylic resin may be a styrene-acrylic resin described below. In addition, in the present specification, the notation “(meth)acrylic” means at least one of acrylic and methacrylic.

The styrene-acrylic resin is a copolymer prepared from a styrene monomer and a (meth)acrylic monomer, and examples thereof include a styrene-acrylic acid copolymer, a styrene-methacrylic acid copolymer, a styrene-methacrylic acid-acrylic ester copolymer, a styrene-α-methylstyrene-acrylic acid copolymer, and a styrene-α-methylstyrene-acrylic acid-acrylic ester copolymer. As the styrene-acrylic resin, a commercial product may be used. For example, Joncryl series 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Movinyl series 966A and 975N (trade names, manufactured by The Nippon Synthetic Chemical Industry Co., Ltd.), Vinylblan 2586 (trade name, manufactured by Nissin Chemical Co., Ltd.), and Bonron S-1120 (trade name, manufactured by Mitsui Chemicals, Inc.) may be used.

The polyolefin resin has olefin, such as ethylene, propylene, or butylene, in the structure skeleton, and an appropriately selected known polyolefin resin can be used. As the olefin resin, commercial products can be used, and for example, Arrowbase CB-1200 or CD-1200 (trade names, manufactured by Unitika Ltd.) may be used.

In addition, the resin particles may be supplied in emulsion form, and examples of commercial product of such resin emulsion include Microgel series E-1002 and E-5002 (trade names, manufactured by Nippon Paint Co., Ltd., styrene-acrylic resin emulsion), VONCOAT 4001 (trade name, manufactured by DIC Corporation, acrylic resin emulsion), VONCOAT 5454 (trade name, manufactured by DIC Corporation, styrene-acrylic resin emulsion), Polysol series AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol series AD-13, AD-2, AD-10, AD-96, AD-17, and AD-70 (ethylene-vinyl acetate resin emulsion), Polysol PSASE-6010 (ethylene-vinyl acetate resin emulsion) (trade names, manufactured by Showa Denko K.K.), SAE1014 (trade name, styrene-acrylic resin emulsion, manufactured by Zeon Corporation), SAIVINOL SK-200 (trade name, acrylic resin emulsion, manufactured by Saiden Chemical Industry Co., Ltd.), AE-120A (trade name, manufactured by JSR Corporation, acrylic resin emulsion), AE373D (trade name, manufactured by Emulsion Technology Co., Ltd., carboxy modified styrene-acrylic resin emulsion), SEIKADYNE 1900W (trade name, manufactured by Dainichiseika Color & Chemicals Mfg. Co., Ltd., ethylene-vinyl acetate resin emulsion), VINYBLAN 2682 (acrylic resin emulsion), VINYBLAN 2886 (vinyl acetate-acrylic resin emulsion), VINYBLAN 5202 (acetic acid acrylic resin emulsion) (trade names, manufactured by Nissin Chemical Co., Ltd.), Takelac series W-6020, W-635, W-6061, W-605, W-635, and W-6021 (trade names, manufactured by Mitsui Chemicals Polyurethanes, Inc., urethane resin emulsion), SUPERFLEX series 870, 800, 150, 420, 460, 470, 610, and 700 (trade names, manufactured by DKS Co., Ltd., urethane resin emulsion), PERMARIN UA-150 (manufactured by Sanyo Chemical Industries, Ltd., urethane resin emulsion), Sancure 2710 (manufactured by The Lubrizol Corporation, urethane resin emulsion), NeoRez series R-9660, R-9637, and R-940 (manufactured by Kusumoto Chemicals, Ltd., urethane resin emulsion), ADEKA BONTIGHTER series HUX-380 and 290K (manufactured by ADEKA Corporation, urethane resin emulsion), Movinyl 966A and Movinyl 7320 (manufactured by The Nippon Synthetic Chemical Industry Co., Ltd.), Joncryl series 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (manufactured by BASF SE), NK Binder R-5HN (manufactured by Shin-Nakamura Chemical Co., Ltd.), HYDRAN WLS-210 (non-crosslinkable polyurethane: manufactured by DIC Corporation), and Joncryl 7610 (manufactured by BASF SE).

The content of the resin particles contained in the aqueous ink jet composition is 0.1 mass % or more and 20 mass % or less as the solid content based on the total mass of the aqueous ink jet composition and may be 1 mass % or more and 15 mass % or less or 2 mass % or more and 10 mass % or less.

### Chelating Agent

The aqueous ink jet composition of the present embodiment may use a chelating agent. The chelating agent can remove a certain ion in the aqueous ink jet composition.

Examples of the chelating agent include ethylenediaminetetraacetic acid and salts thereof, such as EDTA, EDTA-2Na (disodium dihydrogen ethylenediaminetetraacetate), EDTA-3Na (trisodium hydrogen ethylenediaminetetraacetate), EDTA-4Na (tetrasodium ethylenediaminetetraacetate), and EDTA-3K (tripotassium hydrogen ethylenediaminetetraacetate); diethylenetriaminepentaacetic acid and salts thereof, such as DTPA, DTPA-2Na (disodium diethylenetriaminepentaacetate) and DTPA-5Na (pentasodium diethylenetriaminepentaacetate); nitrilotriacetic acid and salts thereof, such as NTA, NTA-2Na (disodium nitrilotriacetate) and NTA-3Na (trisodium nitrilotriacetate); ethylenediamine-N,N′-disuccinic acid and salts thereof; 3-hydroxy-2,2′-iminodisuccinic acid and salts thereof; L-aspartic-N,N′-diacetic acid and salts thereof; and N-(2-hydroxyethyl)iminodiacetic acid and salts thereof.

In addition, examples of the chelating agent other than acetic acid analogues include ethylenediaminetetramethylenephosphonic acid and salts thereof, ethylenediaminetetrametaphosphoric acid and salts thereof, ethylenediaminepyrophosphoric acid and salts thereof, and ethylenediaminemetaphosphoric acid and salts thereof.

When the aqueous ink jet composition of the present embodiment contains a chelating agent, one or more selected from the above-mentioned chelating agents can be used.

### pH Adjuster

The aqueous ink jet composition of the present embodiment can contain a pH adjuster. The pH adjuster is not particularly limited, and examples thereof include an appropriate combination of an acid, a base, a weak acid, and a weak base. Examples of the acid and the base to be used in the combination include inorganic acids, such as sulfuric acid, hydrochloric acid, and nitric acid; inorganic bases, such as lithium hydroxide, sodium hydroxide, potassium hydroxide, potassium dihydrogen phosphate, disodium hydrogen phosphate, potassium carbonate, sodium carbonate, sodium hydrogen carbonate, and ammonia; organic bases, such as triethanolamine, diethanolamine, monoethanolamine, tripropanolamine, triisopropanolamine, diisopropanolamine, and tris(hydroxymethyl)aminomethane (THAM); and organic acids, such as adipic acid, citric acid, succinic acid, and lactic acid; and Good's buffers, such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyliminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycinamide, and bicine; and phosphate buffer, citrate buffer, Tris buffer, etc. may be used. Furthermore, when among these pH adjusters, a tertiary amine, such as triethanolamine and triisopropanolamine, and a carboxyl group-containing organic acid, such as adipic acid, citric acid, succinic acid, and lactic acid, are contained as a part or the whole of the pH adjuster, a pH buffering effect can be more stably obtained.

### Ureas

As a moisturizing agent of the aqueous ink jet composition or as a dyeing assistant for improving the dyeing property of a dye, ureas may be used. Examples of the ureas include urea, ethyleneurea, tetramethylurea, thiourea, and 1,3-dimethyl-2-imidazolidinone. When ureas are contained, the content thereof can be 1 mass % or more and 10 mass % or less based on the total mass of the aqueous ink jet composition.

### Preservative, Fungicide, and Corrosion Inhibitor

The aqueous ink jet composition may use a preservative and a fungicide. Examples of the preservative and fungicide include sodium benzoate, sodium pentachlorophenol, sodium 2-pyridinethiol-1-oxide, sodium sorbate, sodium dehydroacetate, 1,2-dibenzisothiazolin-3-one (PROXEL CRL, PROXEL BDN, PROXEL GXL, PROXEL XL-2, PROXEL TN, and PROXEL LV of ZENECA Inc.), and 4-chloro-3-methylphenol (e.g., PREVENTOL CMK of Bayer AG). Examples of the corrosion inhibitor include benzotriazole.

### Saccharides

In order to suppress the solidification and drying of the aqueous ink jet composition, saccharides may be used. Examples of the saccharides include glucose, mannose, fructose, ribose, xylose, arabinose, galactose, aldonic acid, glucitol (sorbitol), maltose, cellobiose, lactose, sucrose, trehalose, and maltotriose.

### Others

Furthermore, as components other the above-mentioned components, the aqueous ink jet composition may contain additives that can be usually used in aqueous ink jet composition for ink jet, such as an antioxidant, an UV absorber, an oxygen absorber, and a dissolving assistant.

The content of the above-mentioned other components can be 6 mass % or less and may be 5 mass % or less. Incidentally, when multiple other components are contained, the total of contents thereof may satisfy the above-mentioned condition.

### 1.7. Manufacturing and Physical Properties of Aqueous Ink Jet Composition

The aqueous ink jet composition can be obtained by mixing the above-mentioned components in an arbitrary order, performing, for example, filtration as needed, and removing impurities. As the method for the mixing, a method of sequentially adding materials to a container equipped with a stirring device, such as a mechanical stirrer or a magnetic stirrer, and stirring and mixing them may be employed. As the method for filtration, for example, centrifugal filtration or filter filtration can be performed as needed.

The lower limit of surface tension of the aqueous ink jet composition at 25° C. is not particularly limited and may be 20 mN/m, 21 mN/m, or 23 mN/m. In addition, the upper limit of surface tension of the aqueous ink jet composition at 25° C. is not particularly limited and may be 50 mN/m, 40 mN/m, or 30 mN/m.

Consequently, the nozzle of a discharging device of an ink jet system is less likely to be clogged, and the discharge stability of the aqueous ink jet composition is further improved. In addition, even if the nozzle is clogged, the nozzle can be capped, that is, the recoverability by capping can be made more excellent.

Incidentally, as the surface tension, the value measured by a Wilhelmy method can be used. In the measurement of surface tension, for example, a surface tensiometer, such as CBVP-7 manufactured by Kyowa Interface Science Co., Ltd., can be used.

The lower limit of viscosity at 25° C. of the aqueous ink jet composition is not particularly limited and may be 2 mPa·s, 3 mPa·s, or 4 mPa·s. In addition, the upper limit of viscosity at 25° C. of the aqueous ink jet composition is not particularly limited and may be 30 mPa·s, 20 mPa·s, or 10 mPa·s.

Consequently, the discharge stability of the aqueous ink jet composition is further improved.

Incidentally, the viscosity can be measured at 25° C., for example, using a viscoelastometer, such as MCR-300 manufactured by Pysica, by raising the shear rate from 10 [s⁻¹] to 1000 [s⁻¹] and reading the viscosity at the time when the shear rate is 200 [s⁻¹].

When the aqueous ink jet composition is an ink, the ink is usually applied to a recording apparatus by an ink jet method in a state stored in a container, such as a cartridge, a bag, or a tank. In other words, the recording apparatus according to the present disclosure includes a container, such as an ink cartridge, for storing an ink as an aqueous ink jet composition.

### 1.8. Effects

The aqueous ink jet composition of the present embodiment containing 1-(2-hydroxyalkyl)-2-pyrrolidone can enhance the dispersibility of the specific dye and can prevent aggregation and solidification from occurring. When the aggregation and solidification of the specific dye are unlikely to occur, the clogging recovery of the aqueous ink jet composition can be made excellent. In addition, this effect is particularly significant when the concentration of the specific dye in the aqueous ink jet composition is high.

In addition, even if the heat treatment of the recording medium is performed at a relatively low temperature for a relatively short time, an excellent color development property is exhibited. Accordingly, the aqueous ink jet composition can be suitably applied to a recording medium with low heat resistance, for example, a recording medium made of a material that melts or causes unwilling discoloration by heat treatment at a relatively low temperature, and the range of selection of the recording medium is broadened. In addition, since an excellent color development property is exhibited even if the heat treatment of a recording medium is performed at a relatively low temperature for a relatively short time, it is profitable also from the viewpoint of saving energy and improving the productivity of a recorded matter. In addition, as described above, since the ratio of the content of the polyester to the content of the dye is relatively high, even when a recorded matter manufactured using the aqueous ink jet composition is subjected to heat treatment, for example, washing/cleaning with hot water, heat drying with a dryer, or ironing, it is possible to effectively prevent the dye from unwillingly diffusing to the outside of the recorded matter. In addition, the aqueous ink jet composition can be applied to a method for manufacturing a recorded matter without a transferring step from the viewpoint of improving the productivity of a recorded matter, decreasing the production cost of a recorded matter, and resource saving.

These excellent effects are inferred to be obtained by the following reasons. That is, a sublimation dye and a disperse dye have properties of sublimating or diffusing by heating. At the same time, polyester has ester bonds in the main chain, a part of the ester bonds is decomposed into a carboxyl group and a hydroxyl group by heating, and the carboxyl group and the hydroxyl group are recombined by cooling. Accordingly, it is inferred that when at least one of a sublimation dye and a disperse dye and polyester are heated in a state in which they are close to each other, the sublimation dye or the disperse dye becomes a single molecule state by sublimation or dispersion, subsequently, the single molecule state of the sublimation dye or the disperse dye is held in the polyester by cooling, and thereby excellent color development property is exhibited. In addition, even when the movement distance of the sublimation dye or the disperse dye is short comparing to known sublimation transfer, since the single molecule state of the sublimation dye or the disperse dye can be obtained, heat treatment at a relatively low temperature for a relatively short time can also secure a sufficiently excellent color development property.

### 2. METHOD FOR MANUFACTURING RECORDED MATTER

The method for manufacturing a recorded matter includes an imparting step of discharging the aqueous ink jet composition described above by an ink jet method to impart it to a recording medium and a heating step of heating the recording medium imparted with the aqueous ink jet composition.

Consequently, a recorded matter with an excellent color development property can be manufactured. In particular, an excellent color development property can be exhibited against a variety of recording media. In addition, when the imparting step is performed by an ink jet system, very good clogging recovery can be expressed.

### Imparting Step

In the imparting step, the aqueous ink jet composition is discharged by an ink jet system to impart the composition to a recording medium. The discharge of the aqueous ink jet composition by the ink jet system can be performed using a known ink jet recording apparatus. As the discharge method, for example, a piezoelectric system or a system of heating an ink and discharging the ink by the generated bubbles can be used.

In the imparting step, a combination of a plurality of aqueous ink jet compositions may be used. More specifically, for example, a combination of a plurality of aqueous ink jet compositions in which the compositions of the specific dyes are different from each other may be used. In addition, in the imparting step, an ink other than the aqueous ink jet composition according to the present disclosure may be used in combination.

### Recording Medium

The material constituting the recording medium is not particularly limited, and examples thereof include resin materials, such as polyurethane, polyethylene, polypropylene, polyester, polyamide, and an acrylic resin; paper, glass, metal, ceramics, leather, wood, pottery, and fibers made of at least one thereof; and various natural, synthetic, and semi-synthetic fibers, such as silk, hair, cotton, hemp, polyester, polyamide (nylon), acryl, polyurethane, cellulose, linter, rayon, cupra, and acetate. One or a combination of two or more selected from these materials can be used. In addition, the recording medium may have a three-dimensional shape, such as a sheet-like, spherical, or rectangular parallelepiped shape.

The recording medium may be a fabric. There is a great demand for dyeing fabrics in, for example, printed T-shirts. While printing by, e.g., ironing is widespread, there is a strong demand for dyeing fabrics other than polyester fiber fabrics. Accordingly, when the recording medium is a fabric, the above-described effects are more significantly exhibited.

In addition, the recording medium may be made of a material including one or more selected from the group consisting of silk, wool, cellulose, acryl, polyurethane, and polyamide.

These materials have a strong demand for dyeing but are not suitable for dyeing using a sublimation dye or a disperse dye so far because of, for example, the heat-resistant temperature. In contrast, in the present disclosure, even if a recording medium made of such a material is used, a recorded matter can be suitably manufactured. Accordingly, when the recording medium is made of a material including one or more selected from the group consisting of silk, wool, cellulose, acryl, polyurethane, and polyamide, the effects of the aqueous ink jet composition are more significantly exhibited.

Among the fibers used for fabrics, hemp and hair (e.g., wool) are easily fluffed. Easily fluffing hemp and hair come contact with an ink jet head and easily cause nozzle omission, and even if nozzle omission can be avoided, since the fabric has a large number of micro holes and irregularities, the ink is unlikely to land, and the fabric is not suitable for ink jet printing. Cotton, silk, polyester, polyamide, acryl, and polyurethane that are unlikely to fluff are suitable for ink jet printing.

Accordingly, the recording medium may be made of one or more selected from the group consisting of cotton, silk, polyester, polyamide, acryl, and polyurethane.

### Heating Step

Subsequently, the recording medium imparted with the aqueous ink jet composition is heated. Consequently, the specific dye is fixed to the recording medium together with polyester and so on, and the specific dye suitably develops color to give a recorded matter.

The lower limit of the heating temperature in this step is not particularly limited and may be 100° C., 105° C., or 110° C. The upper limit of the heating temperature in this step is not particularly limited and may be 180° C., 160° C., or 150° C.

Consequently, the energy required to manufacture a recorded matter can be reduced, and the productivity of the recorded matter can be further improved. In addition, the color development property of the resulting recorded matter can be further improved. In addition, a recording medium with relatively low heat resistance can also be suitably applied, and the range of selection of the recording medium is further broadened. In addition, it is possible to suitably prevent, for example, unwilling discoloration and a change in optical density by heating after manufacturing the recorded matter, for example, by heat treatment, such as washing/cleaning with hot water, heat drying with a dryer, or ironing.

In addition, when a recording medium with relatively high heat resistance, for example, paper, glass, ceramics, metal, or wood, is used, the upper limit of the heating temperature in this step can be 250° C. and may be 220° C. or 200° C.

Although the heating time in this step varies depending on the heating temperature, the lower limit of the heating time in this step can be 0.2 seconds and may be 1 second or 5 seconds. In addition, the upper limit of the heating time in this step can be 300 seconds and may be 60 seconds or 30 seconds.

Consequently, the energy required to manufacture a recorded matter can be reduced, and the productivity of the recorded matter can be further improved. In addition, the color development property of the resulting recorded matter can be further improved. In addition, a recording medium with relatively low heat resistance can also be suitably applied, the range of selection of the recording medium is further broadened.

In addition, although this step can be performed by heating the surface of the recording medium imparted with the aqueous ink jet composition in a state of being separated from the heating member or can be performed by heating in a state in which the recording medium imparted with the aqueous ink jet composition and the heating member are in contact with each other, heating may be performed by heating in a state in which the recording medium imparted with the aqueous ink jet composition and the heating member are in contact with each other.

Consequently, the energy required to manufacture a recorded matter can be reduced, and the productivity of the recorded matter can be further improved. In addition, the color development property of the resulting recorded matter can be further improved. In addition, the specific dye can be more effectively prevented from diffusing to the outside of the recording medium.

The method for manufacturing a recorded matter may further include other steps, in addition to the above-described steps, such as a preprocessing step, an intermediate processing step, a postprocessing step, and a transferring step. As the preprocessing step, for example, a step of applying a coat layer to the recording medium is mentioned. As the intermediate processing step, for example, a step of preheating the recording medium is mentioned. As the postprocessing step, for example, a step of washing the recording medium is mentioned. As the transferring step, a step of sublimation transferring the specific dye to the recording medium to be dyed after the imparting step of imparting the aqueous ink jet composition to an intermediate transfer medium is mentioned.

In the present specification, the term “(meth)acrylic” represents acrylic or methacrylic, and the term “(meth)acrylate” refers to acrylate or methacrylate.

### 3. AQUEOUS INK JET INK COMPOSITION

An aqueous ink jet ink composition (hereinafter, also simply referred to as “ink composition”) according to one embodiment of the present disclosure contains a pigment, 1-(2-hydroxyalkyl)-2-pyrrolidone, trimethylglycine, and an organic amine. Each of the components contained in the aqueous ink jet ink composition according to the present embodiment will now be described.

### 3.1. Pigment

The ink composition according to the present embodiment contains a pigment as a color material. As the pigment, pigments that are usually used in aqueous pigment inks for ink jet can be used without specific limitation.

As the pigment, for example, organic pigments, such as azo pigments (e.g., azo lake, insoluble azo pigment, condensed azo pigment, and chelate azo pigment), polycyclic pigments (e.g., phthalocyanine pigment, perylene pigment, perinone pigment, anthraquinone pigment, quinacridone pigment, dioxazine pigment, thioindigo pigment, isoindolinone pigment, and quinophthalone pigment), nitro pigments, nitroso pigments, and aniline black; inorganic pigments, such as carbon black (e.g., furnace black, thermal lamp black, acetylene black, and channel black), metal oxides, metal sulfides, and metal chlorides; and extender pigments, such as silica, calcium carbonate, and talc can be used.

Examples of the pigments include C.I. Pigment Yellow 64, 74, 93, 109, 110, 128, 138, 139, 150, 151, 154, 155, 180, and 185; C.I. Pigment Red 122, 202, and 209; C.I. Pigment Violet 19; C.I. Pigment Blue 15:3, 15:4, and 60; C.I. Pigment Green 7 (phthalocyanine green), 10 (green gold), 36, and 37; C.I. Pigment Brown 3, 5, 25, and 26; and C.I. Pigment Orange 1, 2, 5, 7, 13, 14, 15, 16, 34, 36, 38, 64, and 71.

Among these pigments, a phthalocyanine pigment may be used, and at least one of C.I. Pigment Blue 15:3 and C.I. Pigment Blue 15:4 may be used. The ink composition containing a phthalocyanine pigment can reduce the content of the pigment compared to various other color inks and is relatively unlikely to be dry-solidified, and nozzle omission is unlikely to occur. However, the ink composition containing a phthalocyanine pigment that has been solidified once forms a firm solid content and is therefore not re-dispersed even if subsequent ink arrives. Accordingly, there is a problem that if a solid content is formed near a nozzle by the ink composition containing a phthalocyanine pigment, the probability of causing permanent nozzle omission that is never recovered is high compared to various other color inks. In contrast, the ink composition according to the present embodiment can drastically improve the water dispersibility of the pigment by containing 1-(2-hydroxyalkyl)-2-pyrrolidone in an amount of not higher than the content of the pigment. In addition, since trimethylglycine is added in an amount of not lower than the content of the pigment, the trimethylglycine easily penetrates between pigment particles, aggregation of the pigment is prevented, and even if the pigment aggregates to form a solid content, trimethylglycine dissolves the solid content to cause re-dispersion. Accordingly, formation of a firm solid content is reduced even in the use of a phthalocyanine pigment, and even if a solid content is formed, re-dispersibility is high, and permanent nozzle omission that is never recovered can be prevented from occurring.

The pigment may be added to an ink composition as a pigment dispersion obtained by dispersing the pigment in water by a dispersant or a pigment dispersion obtained by dispersing a self-dispersible surface-treated pigment having a hydrophilic group introduced to the pigment particle surface by means of a chemical reaction in water or by dispersing a polymer-coated pigment in water.

The pigments and the dispersants constituting the pigment dispersion may be, respectively, used singly or in combination of two or more.

The content of the pigment (solid content) can be 3.0 mass % or more based on the total mass (100 mass %) of the ink composition and may be 4.0 mass % or more. The content of the pigment (solid content) can be 8.0 mass % or less based on the total mass (100 mass %) of the ink composition and may be 7.0 mass % or less or 6.0 mass % or less. When the content of the pigment (solid content) is within the above-mentioned range, clear images can be formed on various types of recording media, and occurrence of solid content due to dry solidification of the ink composition can be reduced.

3.2. 1-(2-Hydroxyalkyl)-2-pyrrolidone

The ink composition according to the present embodiment contains 1-(2-hydroxyalkyl)-2-pyrrolidone. The humectant of an ink composition has been 2-pyrrolidone in many cases and has not been 1-(2-hydroxyalkyl)-2-pyrrolidone. However, it was proven that the water dispersibility of a pigment can be drastically improved by adding 1-(2-hydroxyalkyl)-2-pyrrolidone in an amount of not higher than the content of the pigment to the ink composition. Consequently, formation of a firm solid content derived from the pigment is reduced, and even if a solid content is formed, re-dispersibility is high, and permanent nozzle omission that is never recovered can be prevented from occurring.

Examples of the 1-(2-hydroxyalkyl)-2-pyrrolidone include 1-(2-hydroxymethyl)-2-pyrrolidone, 1-(2-hydroxyethyl)-2-pyrrolidone, and 1-(2-hydroxypropyl)-2-pyrrolidone. Among these compounds, at least one of 1-(2-hydroxyethyl)-2-pyrrolidone and 1-(2-hydroxypropyl)-2-pyrrolidone may be used, and 1-(2-hydroxyethyl)-2-pyrrolidone may be used.

The content of the 1-(2-hydroxyalkyl)-2-pyrrolidone can be 1.0 mass % or more based on the total mass (100 mass %) of the ink composition and may be 1.5 mass % or more or 2.0 mass % or more. The content of the 1-(2-hydroxyalkyl)-2-pyrrolidone can be 5.0 mass % or less based on the total mass (100 mass %) of the ink composition and may be 4.5 mass % or less or 4.0 mass % or less. When the content of the 1-(2-hydroxyalkyl)-2-pyrrolidone is within the above-mentioned range, the water dispersibility of the pigment is improved, and firm solidification of the pigment can be easily reduced.

### 3.3. Trimethylglycine

The ink composition according to the present embodiment contains trimethylglycine. Since trimethylglycine is very easily dissolved in water, a large amount thereof can be added to the ink composition. When trimethylglycine is added to the ink composition in an amount of not lower than the content of the pigment, the trimethylglycine easily penetrates between pigment particles, and aggregation of the pigment is prevented. Even if the pigment aggregates to form a solid content, since the trimethylglycine can dissolve the solid content to cause re-dispersion, permanent nozzle omission that is never recovered can be prevented from occurring.

The content of the trimethylglycine can be 5.0 mass % or more based on the total mass (100 mass %) of the ink composition and may be 5.5 mass % or more or 6.0 mass % or more. The content of the trimethylglycine can be 20.0 mass % or less based on the total mass (100 mass %) of the ink composition and may be 15.0 mass % or less or 13.0 mass % or less. When the content of the trimethylglycine is within the above-mentioned range, the water dispersibility of the pigment is improved, and formation of a solid content of the pigment can be easily reduced.

### 3.4. Organic Amine

The ink composition according to the present embodiment contains an organic amine. The organic amine has an effect of suppressing occurrence of nozzle omission. In addition, the organic amine has a function as a weak alkaline pH adjuster. In addition, when the organic amine is amphiphilic, the ink composition has excellent long term stability. Accordingly, among the above-mentioned organic amines, an alkanolamine may be used. Furthermore, since clogging can be prevented by using an alkanolamine having a high boiling point, trialkanolamine, in particular, at least one of tripropanolamine and triethanolamine, may be used.

The organic amines may be used singly or in combination of two or more.

The content of the organic amine can be 0.05 mass % or more based on the total mass (100 mass %) of the ink composition and may be 0.1 mass % or more. The content of the organic amine can be 2.0 mass % or less based on the total mass (100 mass) of the ink composition and may be 1.0 mass % or less. When the content of the organic amine is within the above-mentioned range, the pH of the ink composition can be adjusted within an appropriate range.

### 3.5. Quantity Ratio Relationship of Each Component

In the ink composition according to the present embodiment, the pigment, the 1-(2-hydroxyalkyl)-2-pyrrolidone, and the trimethylglycine have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine. When the ink composition according to the present embodiment has this quantity ratio relationship, the water dispersibility of the pigment is drastically improved, and formation of a solid content by aggregation of the pigment can be reduced. In addition, even if a solid content derived from the pigment is formed, the solid content is re-dispersed to prevent occurrence of permanent nozzle omission that is never recovered. That is, discharge by all nozzles can be recovered by cleaning the nozzles.

In addition, in the ink composition according to the present embodiment, the organic amine may have a relationship M_{D}≤M_{B}, where M_{D} is the content (mass %) of the organic amine. When the ink composition according to the present embodiment has this quantity ratio relationship, the pH of the ink composition can be adjusted to be weakly alkaline, the long term stability is improved, and occurrence of nozzle omission may be more effectively suppressed.

Incidentally, all of 1-(2-hydroxyalkyl)-2-pyrrolidone, trimethylglycine, and organic amine are nitrogen-containing compounds and also have high affinity to water. When the pigment is a nitrogen-containing compound, such as a phthalocyanine pigment, it is inferred that these four nitrogen-containing compounds have very high affinity. It is accordingly inferred that the dispersibility of these four nitrogen-containing compounds in water is improved to prevent that the phthalocyanine pigment only firmly solidifies and to improve the re-dispersibility.

### 3.6. Other Component

The ink composition according to the present embodiment may contain an additive other the above-mentioned components. Examples of the additive are shown below.

### Water

The ink composition according to the present embodiment contains water as the main solvent. The water to be used may be pure water, such as ion-exchanged water, ultrafiltered water, reverse osmosis water, or distilled water, or ultrapure water. In particular, the use of water sterilized by, for example, UV irradiation or addition of hydrogen peroxide can prevent the outbreak of mold and bacteria to allow the ink composition to be stored for a long time.

### Humectant

The ink composition according to the present embodiment may contain a water-soluble organic solvent having a moistening effect for the purpose of preventing clogging near the nozzle of the ink jet head.

Examples of the humectant include polyhydric alcohols, such as glycerin, 1,2,6-hexanetriol, trimethylolpropane, pentamethylene glycol, trimethylene glycol, ethylene glycol, propylene glycol, diethylene glycol, triethylene glycol, tetraethylene glycol, pentaethylene glycol, polyethylene glycol having a number average molecular weight of 2,000 or less, dipropylene glycol, tripropylene glycol, isobutylene glycol, 2-butene-1,4-diol, 2-ethyl-1,3-hexanediol, 2-methyl-2,4-pentanediol, meso-erythritol, and pentaerythritol; saccharides, such as glucose, mannose, fructose, ribose, xylose, arabinose, galactose, aldonic acid, glucitol (sorbitol), maltose, cellobiose, lactose, sucrose, trehalose, and maltotriose; so-called solid humectants, such as sugar alcohols, hyaluronic acids, and ureas; alkyl alcohols having 1 to 4 carbon atoms, such as ethanol, methanol, butanol, propanol, and isopropanol; and 2-pyrrolidone, N-methyl-2-pyrrolidone, 1,3-dimethyl-2-imidazolidinone, formamide, acetamide, dimethyl sulfoxide, sorbitan, acetylene, diacetin, triacetin, and sulfolane.

The humectants may be used singly or in combination of two or more.

The content of the humectant can be 2.0 mass % or more and 20.0 mass % or less based on the total mass (100 mass %) of the ink composition and may be 5.0 mass % or more and 15.0 mass % or less. When the content of the humectant is within the above-mentioned range, appropriate physical values (such as viscosity) of the ink composition can be secured, and the quality and reliability of recording can be secured.

### Penetrant

The ink composition according to the present embodiment may contain a penetrant for the purpose of accelerating penetration of the aqueous solvent into a recording medium. A recorded matter with less bleeding of an image can be obtained by rapid penetration of the aqueous solvent into the inside of the recording medium.

As the penetrant, at least one of alkyl ethers (also referred to as glycol ethers) of polyhydric alcohols and 1,2-alkyldiols may be used. Examples of the alkyl ether of a polyhydric alcohol include ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol monopropyl ether, ethylene glycol monoisopropyl ether, diethylene glycol monoisopropyl ether, ethylene glycol monobutyl ether, diethylene glycol monobutyl ether, triethylene glycol monobutyl ether, ethylene glycol mono-tert-butyl ether, diethylene glycol mono-tert-butyl ether, 1-methyl-1-methoxybutanol, propylene glycol monomethyl ether, propylene glycol monoethyl ether, propylene glycol mono-tert-butyl ether, propylene glycol monopropyl ether, propylene glycol monoisopropyl ether, dipropylene glycol monomethyl ether, dipropylene glycol monoethyl ether, dipropylene glycol monopropyl ether, dipropylene glycol monoisopropyl ether, propylene glycol monobutyl ether, and dipropylene glycol monobutyl ether. Examples of the 1,2-alkyldiol include 1,2-pentanediol and 1,2-hexanediol. In addition to these diols, the examples include straight chain hydrocarbon diols, such as 1,3-propanediol, 1,4-butanediol, 1,5-pentanediol, 1,6-hexanediol, 1,7-heptanediol, and 1,8-octanediol.

The penetrants may be used singly or in combination of two or more.

The content of the penetrant can be 1.0 mass % or more and 20.0 mass % or less based on the total mass (100 mass %) of the ink composition and may be 2.0 mass % or more and 15.0 mass % or less. When the content of the penetrant is within the above-mentioned range, the permeability of the ink composition into the inside of a recording medium can be improved, occurrence of bleeding in the image recorded using the ink composition can be prevented, and the viscosity of the ink composition can be prevented from becoming too high.

### Surfactant

The ink composition according to the present embodiment may contain a surfactant for the purpose of adjusting the surface tension and the wettability of the ink composition and improving the discharge stability.

The surfactant is not particularly limited, and a nonionic surfactant, for example, at least one of an acetylene glycol surfactant and a silicone surfactant, may be used.

Examples of the acetylene glycol surfactant include Surfynol series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (trade names, manufactured by Air Products and Chemicals, Inc.), Olfine series B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (trade names, manufactured by Nissin Chemical Co., Ltd.), and Acetylenol series E00, E00P, E40, and E100 (trade names, manufactured by Kawaken Fine Chemicals Co., Ltd.).

Examples of the silicone surfactant include polysiloxane compounds and polyether modified organosiloxane. The commercial product of the silicone surfactant is not particularly limited, and examples thereof include BYK-306, BYK-307, BYK-333, BYK-341, BYK-345, BYK-346, BYK-347, BYK-348, and BYK-349 (trade names, manufactured by BYK Chemie Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.), and SILFACE 503A and SILFACE 014 (trade names, manufactured by Nissin Chemical Co., Ltd.).

The surfactants may be used singly or in combination of two or more.

The content of the surfactant can be 0.1 mass % or more and 2.0 mass % or less based on the total mass (100 mass %) of the ink composition and may be 0.2 mass % or more and 1.2 mass % or less. When the content of the surfactant is within the above-mentioned range, the discharge stability may be further improved.

### 4. INK SET

An ink set according to one embodiment of the present disclosure includes a first ink and a second ink different from the first ink in color. The first ink and the second ink each contain a pigment, 1-(2-hydroxyalkyl)-2-pyrrolidone, trimethylglycine, and an organic amine. In each of the first ink and the second ink, the pigment, the 1-(2-hydroxyalkyl)-2-pyrrolidone, and the trimethylglycine have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine.

That is, the ink set according to the present embodiment includes two or more types of the above-described aqueous ink jet ink compositions having different colors.

If the second ink does not contain 1-(2-hydroxyalkyl)-2-pyrrolidone and/or trimethylglycine, it is presumed that dry solidification is likely to progress when the first ink and the second ink are mixed with each other during the operation of wiping the nozzle surface or inside the head cap. In contrast, since the ink set according to the present embodiment includes two or more types of the above-described aqueous ink jet ink compositions, the water dispersibility of the pigment is drastically improved, and formation of a solid content by aggregation of the pigment can be reduced. In addition, even if a solid content derived from the pigment is formed, the solid content is re-dispersed to prevent occurrence of permanent nozzle omission that is never recovered. That is, discharge of all nozzles can be recovered by cleaning the nozzles.

In the present disclosure, the phrase “colors are different” means that the hue angles ∠H° are different from each other by 20° or more. The hue angle ∠H° is determined by ∠H°=tan⁻¹ (b*/a*)+180 (when a*<0) or ∠H°=tan⁻¹ (b*/a*)+360 (when a*>0). The a* and b* refer to perceptual chromaticity indexes defined in the CIELAB color space.

In the ink set according to the present embodiment, the first ink may be a cyan ink composition for aqueous ink jet. In addition, the pigment contained in the first ink may be a phthalocyanine pigment, such as at least one of C.I. Pigment Blue 15:3 and C.I. Pigment Blue 15:4.

In the ink set according to the present embodiment, the second ink may be a single ink or may be composed of two or more inks. The second ink is not particularly limited and may be at least one of a yellow ink composition for aqueous ink jet, a magenta ink composition for aqueous ink jet, and a black ink composition for aqueous ink jet.

### 5. INK JET RECORDING APPARATUS

In an ink jet recording apparatus according to one embodiment of the present disclosure, a single head cap seals two or more inks each containing a pigment, 1-(2-hydroxyalkyl)-2-pyrrolidone, trimethylglycine, and an organic amine, and the pigment, the 1-(2-hydroxyalkyl)-2-pyrrolidone, and the trimethylglycine in each of the two or more inks have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine.

An example of the structure of the ink jet recording apparatus (hereinafter, also simply referred to as “recording apparatus”) according to the present embodiment will now be described with reference to FIGURE. In the X-Y-Z coordinate system shown in FIGURE, the X direction is the length direction of the recording medium, the Y direction is the width direction of the recording medium in the transport path inside the recording apparatus, and the Z direction is the height direction of the apparatus.

An example of the recording apparatus 10 is a line type ink jet printer that can perform high-speed and high-density printing. The recording apparatus 10 includes a feed section 12 for storing a recording medium P, such as paper, a transport section 14, a belt transport section 16, a record section 18, an Fd (face down) discharge section 20 as a “carrying out section”, an Fd (face down) mounting section 22 as a “mounting section”, a reverse path section 24 as a “reverse feeding mechanism”, an Fu (face up) discharge section 26, and an Fu (face up) mounting section 28.

The feed section 12 is disposed at the lower portion of the recording apparatus 10. The feed section 12 includes a feeding tray 30 for storing the recording medium P and a feeding roller 32 stored in the feeding tray 30 and sending the recording medium P to the transport path 11.

The recording medium P stored in the feeding tray 30 is fed to the transport section 14 by the feeding roller 32 along the transport path 11. The transport section 14 includes a transport driving roller 34 and a transport following roller 36. The transport driving roller 34 is rotary-driven by a driving force (not shown). In the transport section 14, the recording medium P is pinched (nipped) between the transport driving roller 34 and the transport following roller 36 and is transported to the belt transport section 16 located on the downstream of the transport path 11.

The belt transport section 16 includes a first roller 38 located on the upstream in the transport path 11 and a second roller 40 located on the downstream, an endless belt 42 installed on the first roller 38 and the second roller 40 so as to be rotationally movable, and a supporter 44 supporting the upper side section 42a of the endless belt 42 between the first roller 38 and the second roller 40.

The endless belt 42 is driven by the first roller 38 or the second roller 40 that is driven by a driving force (not shown) and thereby moves from the +X direction to the −X direction in the upper side section 42a. Consequently, the recording medium P transported from the transport section 14 is further transported to the downstream of the transport path 11 in the belt transport section 16.

The record section 18 includes a line type ink jet head 48 and a head holder 46 holding the ink jet head 48. Incidentally, the record section 18 may be of a serial type in which an ink jet head is provided on a carriage that reciprocates in the Y-axis direction. The ink jet head 48 is disposed so as to face the upper side section 42a of the endless belt 42 supported by the supporter 44. The ink jet head 48 discharges an ink toward a recording medium P when the recording medium P is transported in the upper side section 42a of the endless belt 42 to carry out recording. The recording medium P is transported to the downstream of the transport path 11 by the belt transport section 16 while performing recording. Incidentally, the ink jet head 48 is sealed with a head cap (not shown) at the bottom face for preventing the ink in the stand-by state from drying.

Incidentally, the “line type ink jet head” is a head that is used in a recording apparatus in which the nozzle region formed in a direction crossing to the transport direction of the recording medium P is provided so as to be capable of covering the entire of the recording medium P in the cross direction, one of the head and the recording medium P is fixed, and the other is moved to form an image. Incidentally, the nozzle region in the cross direction of the line head need not cover the entire of the cross direction of all recording media P to which the recording apparatus corresponds.

In addition, a first diverging portion 50 is provided on the downstream of the transport path 11 of the belt transport section 16. The first diverging portion 50 is configured such that it is possible to switch between the transport path 11 transporting a recording medium P to the Fd discharge section 20 or the Fu discharge section 26 and the reverse path 52 of the reverse path section 24 reversing the recording surface of the recording medium P and transporting the recording medium P to the record section 18 again. Incidentally, the recording surface is reversed by the first diverging portion 50 during the transport process in the reverse path 52, and the recording medium P is transported to the record section 18 such that the surface on the opposite side to the first recording surface faces the ink jet head 48.

A second diverging portion 54 is further provided on the downstream of the first diverging portion 50 along the transport path 11. The second diverging portion 54 is configured such that the transport direction of the recording medium P can be switched to transport the recording medium P toward the Fd discharge section 20 or to transport the recording medium P toward the Fu discharge section 26.

The recording medium P transported toward the Fd discharge section 20 in the second diverging portion 54 is discharged from the Fd discharge section 20 and is mounted on the Fd mounting section 22. On this occasion, the recording medium P is mounted such that the recording surface faces the Fd mounting section 22. In addition, the recording medium P transported toward the Fu discharge section 26 in the second diverging portion 54 is discharged from the Fu discharge section 26 and is mounted on the Fu mounting section 28. On this occasion, the recording medium P is mounted such that the recording surface of the recording medium P faces the side opposite to the Fu mounting section 28.

When at least one ink among two or more inks sealed with a single head cap does not contain 1-(2-hydroxyalkyl)-2-pyrrolidone and/or trimethylglycine, it is presumed that dry solidification is likely to progress when the first ink and the second ink are mixed with each other during the operation of wiping the nozzle surface or inside the head cap. In contrast, in the ink jet recording apparatus according to the present embodiment, since two or more inks are sealed with a single head cap are respectively the above-described aqueous ink jet ink compositions, the effect of preventing occurrence of permanent nozzle omission is exhibited even if color mixing occurs at the time of wiping the nozzle surface of the head or color mixing occurs in the head cap during cleaning.

### 6. EXAMPLES

The present disclosure will now be further specifically described by examples, but is not limited to these examples. Hereinafter, “%” is based on mass unless otherwise specified.

### 6.1. Preparation of Aqueous Ink Jet Composition

Components making each composition shown in Table 1 were stirred with a high-shear mixer (manufactured by Silverson) at 3000 rpm to produce each slurry. Subsequently, the produced slurry and glass beads having a diameter of 0.5 mm were subjected to stirring dispersion with a bead mill (LMZ015, Ashizawa Finetech Ltd.) under water cooling to manufacture an ink jet ink as an aqueous ink jet composition of each example.

TABLE 1

| | | | | | | | | | Comparative | | | |
|---|---|---|---|---|---|---|---|---|---|---|---|---|
| | | Example | | | | | | | Example | | | |
| | | 1 | 2 | 3 | 4 | 5 | 6 | 7 | 1 | 2 | 3 | 4 |
| Ink | C.I. Disperse Red 60 | 0.8 | — | — | — | 7.5 | — | 0.8 | — | — | — | 1.0 |
| composition | C.I. Disperse Blue 191 | — | 0.1 | — | — | — | 3.0 | — | 1.0 | — | — | — |
| | C.I. Disperse Yellow 154 | — | — | 1.0 | — | — | — | — | — | 0.1 | — | — |
| | C.I. Disperse Red 364 | — | — | — | 0.5 | — | — | — | — | — | 1.0 | — |
| | Polyester | 20.0 | 30.0 | 4.0 | 25.0 | 30.0 | 20.0 | 20.0 | 3.0 | 35.0 | — | 10.0 |
| | Styrene-acrylic resin | — | — | — | — | — | — | — | — | — | 10.0 | — |
| | Glycerin | 6.0 | 6.0 | 6.0 | 6.0 | 6.0 | 6.0 | 6.0 | 6.0 | 6.0 | 6.0 | 6.0 |
| | Triethylene glycol | 2.0 | 2.0 | 2.0 | 2.0 | 2.0 | 2.0 | 2.0 | 2.0 | 2.0 | 2.0 | 2.0 |
| | monobutyl ether | | | | | | | | | | | |
| | 2-Pyrrolidone | — | — | — | — | — | — | 1.0 | — | — | — | 3.0 |
| | 1-(2-Hydroxyethyl)- | 1.0 | — | 4.0 | — | 1.0 | 2.0 | 1.0 | 5.0 | 1.0 | 2.0 | — |
| | 2-pyrrolidone | | | | | | | | | | | |
| | 1-(2-Hydroxypropyl)- | — | 2.0 | — | 2.0 | — | — | — | — | — | — | — |
| | 2-pyrrolidone | | | | | | | | | | | |
| | Triethanolamine | 0.5 | 0.2 | 2.0 | 0.5 | 0.5 | 0.5 | 0.5 | 0.5 | 2.0 | 1.0 | 1.0 |
| | Olfine E1010 | 1.0 | 1.0 | 1.0 | 1.0 | 1.0 | 1.0 | 1.0 | 1.0 | 1.0 | 1.0 | 1.0 |
| | Water | 68.7 | 58.7 | 80.0 | 63.0 | 52.0 | 65.5 | 67.7 | 81.5 | 52.9 | 77.0 | 76.0 |
| PEs/dye (mass ratio) | | 25.0 | 300.0 | 4.0 | 50.0 | 4.0 | 6.67 | 25.0 | 3.0 | 350.0 | 10.0 | 10.0 |
| Evaluation | Number of nozzles with | 0 | 0 | 0 | 0 | 0 | 0 | 0 | 0 | 0 | 53 | 58 |
| result | nozzle omission (total | | | | | | | | | | | |
| | number of nozzles: 800) | | | | | | | | | | | |
| | Ink color development | A | A | A | A | A | A | A | B | C | B | A |
| | Fixability (tape peeling | A | A | A | A | A | A | A | A | A | B | A |
| | test) | | | | | | | | | | | |

In Table 1, the polyester used was ELITEL (registered trademark) KT9204 manufactured by Unitika Ltd. The styrene-acrylic resin used was Bonron S-1120 manufactured by Mitsui Chemicals, Inc. Olfine E1010 is an acetylene glycol surfactant manufactured by Nissin Chemical Co., Ltd. Table 1 has a column of “PEs/dye”, and the ratio of the content (mass %) of the polyester to the content (mass %) of the dye is shown.

### 6.2. Method of Evaluation

### 6.2.1. Evaluation of Clogging Recovery

As evaluation of clogging recovery, the number of nozzles with nozzle omission was checked. The aqueous ink jet composition of each example was introduced to the cartridge of PX-M860F ink jet printer manufactured by SEIKO EPSON CORPORATION, and printing was performed. As conditions for causing nozzle omission, the power was turned off during printing, the printer was left to stand at 40° C. for 1 day in a state in which the head was out of the cap, the cleaning was operated 5 times, a check pattern was printed, and the number of nozzles with nozzle omission was counted. The number of nozzles with nozzle omission in each example is shown in Table 1.

### 6.2.2. Evaluation of Color Development Property

Each of the aqueous ink jet compositions of Examples and Comparative Examples was discharged with a recording apparatus PX-M860F (manufactured by SEIKO EPSON CORPORATION) in a predetermined pattern toward an intermediate transfer medium, TRANSJET Classic (manufactured by Cham Paper).

Subsequently, the surface of the intermediate transfer medium imparted with the aqueous ink jet composition was adhered to a polyester fabric as a recording medium, and heating was performed in this state with a heat press machine (TP-608M, manufactured by Horizon International Inc.) at 200° C. for 60 seconds for sublimation transfer to obtain each recorded matter. The resulting recorded matters were each visually evaluated for the color development property based on the following criteria, and the results are shown in Table 1.

A: color is developed,

B: the color is cloudy without color development, and

C: the color is too light.

### 6.2.3. Evaluation of Fixability

A predetermined pattern was recorded using each of the aqueous ink jet compositions of Examples and Comparative Examples on a PET film with a recording apparatus PX-M860F (manufactured by SEIKO EPSON CORPORATION). The resulting recorded matters were dried at room temperature for 12 hours, and Scotch tape manufactured by 3M was then attached to the pattern portion. Then, the tape was peeled as a tape peeling test, and thereby the fixability was evaluated. The evaluation was based on the following criteria, and the results are shown in Table 1.

A: without peeling, and

B: with peeling.

### 6.3. Evaluation Results

In all the aqueous ink jet compositions of Examples each including a dye component composed of at least one of sublimation dyes and disperse dyes, polyester, 1-(hydroxyalkyl)-2-pyrrolidone, and water, wherein the content (mass %) of polyester is 4.0 times or more and 300.0 times or less the content (mass %) of the dye component, the results of the clogging recovery and the color development property of printing were excellent.

In contrast, in Comparative Example 1 having a polyester content (mass %) of 3.0 times the content of the dye component, although the clogging recovery was good because 1-(hydroxyalkyl)-2-pyrrolidone was contained, the color development property was insufficient. In addition, in Comparative Example 2 having a polyester content (mass %) of 350.0 times the content of the dye component, although the clogging recovery was good because 1-(hydroxyalkyl)-2-pyrrolidone was contained, the color development property was insufficient. In Comparative Example 3 using a styrene-acrylic resin instead of polyester, no color development property was obtained, and fixability was also poor. In Comparative Example 4 not containing 1-(hydroxyalkyl)-2-pyrrolidone, the clogging recovery was insufficient.

### 6.4. Preparation of Aqueous Ink Jet Ink Composition

Each component was mixed with the other at the contents shown in Table 2 below, stirred at room temperature for 2 hours, and then filtered through a membrane filter with a pore size of 5 μm to obtain each ink composition. Incidentally, the unit of the content of each ink composition shown in Table 2 is mass %.

### 6.5. Method of Evaluation

6.5.1. Evaluation of Number of Nozzles with Nozzle Omission

The ink compositions obtained above were each put in an ink cartridge of a printer PX-M860F manufactured by SEIKO EPSON CORPORATION, and printing was performed. As conditions for causing nozzle omission, the power was turned off during printing, the printer was left to stand under an environment of 40° C. for 1 day, 40° C. for 7 days, or 40° C. for 14 days in a state in which the head was out of the cap, then the cleaning was operated once, and the number of nozzles with nozzle omission under each environment was counted. Furthermore, the power was turned off during printing, the printer was left to stand under an environment of 40° C. for 1 day, 40° C. for 7 days, or 40° C. for 14 days in a state in which the head was out of the cap, then the cleaning was operated 20 times, and the number of nozzles with nozzle omission under each environment was counted. In this evaluation of the number of nozzles with nozzle omission, when permanent nozzle omission did not occur after the cleaning 20 times, it can be judged to be good.

### 6.6. Evaluation Results

Table 2 shows the composition of the aqueous ink jet ink composition used in each of Examples and Comparative Examples and the evaluation results.

TABLE 2

| | | | | | | | | | Comparative |
|---|---|---|---|---|---|---|---|---|---|
| | | Example 1 | Example 2 | Example 3 | Example 4 | Example 5 | Example 6 | Example 7 | Example 1 |
| Ink | Carbon black | | | | 5 | | | | 5 |
| composition | Cyan pigment (P.B. 15:3) | 5 | | | | | | | |
| | Cyan pigment (P.B. 15:4) | | 5 | | | 5 | 5 | 5 | |
| | Magenta pigment (P.R. 122) | | | 5 | | | | | |
| | Glycerin | 8 | 8 | 8 | 8 | 8 | 8 | 8 | 8 |
| | Triethylene glycol | 3 | 3 | 3 | 3 | 3 | 3 | 3 | 3 |
| | monobutyl ether | | | | | | | | |
| | 2-Pyrrolidone | | | | | | | 2 | 2 |
| | 1-(2-Hydroxyethyl)- | 1 | 2 | 4 | 1 | | 5 | 2 | |
| | 2-pyrrolidone | | | | | | | | |
| | 1-(2-Hydroxypropyl)- | | | | | 2 | | | |
| | 2-pyrrolidone | | | | | | | | |
| | Triethanolamine | 0.5 | 0.2 | 2 | 0.5 | 0.2 | 0.2 | 0.2 | 0.5 |
| | Trimethylglycine | 7 | 6 | 10 | 13 | 6 | 5 | 6 | 7 |
| | Olfine E1010 | 1 | 1 | 1 | 1 | 1 | 1 | 1 | 1 |
| | Water | 74.5 | 74.8 | 67 | 68.5 | 74.8 | 72.8 | 72.8 | 73.5 |
| Number of | After leaving to stand at | 24 | 15 | 12 | 6 | 18 | 25 | 18 | 30 |
| nozzles | 40° C. for 1 day and | | | | | | | | |
| with nozzle | cleaning once | | | | | | | | |
| omission | After leaving to stand at | 252 | 186 | 165 | 62 | 212 | 273 | 224 | 240 |
| (total | 40° C. for 7 days and | | | | | | | | |
| number of | cleaning once | | | | | | | | |
| nozzles: | After leaving to stand at | 437 | 227 | 241 | 98 | 353 | 365 | 327 | 590 |
| 800) | 40° C. for 14 days and | | | | | | | | |
| | cleaning once | | | | | | | | |
| Number of | After leaving to stand at | 0 | 0 | 0 | 0 | 0 | 0 | 0 | 0 |
| nozzles | 40° C. for 1 day and | | | | | | | | |
| with nozzle | cleaning 20 times | | | | | | | | |
| omission | After leaving to stand at | 0 | 0 | 0 | 0 | 0 | 0 | 0 | 0 |
| after | 40° C. for | | | | | | | | |
| cleaning | 7 days and cleaning 20 times | | | | | | | | |
| 20 times | After leaving to stand at | 0 | 0 | 0 | 0 | 0 | 0 | 0 | 3 |
| | 40° C. for 14 days and | | | | | | | | |
| | cleaning 20 times | | | | | | | | |

| | | Comparative | Comparative | Comparative | Comparative | Comparative |
|---|---|---|---|---|---|---|
| | | Example 2 | Example 3 | Example 4 | Example 5 | Example 6 |
| Ink | Carbon black | | | | | |
| composition | Cyan pigment | 5 | | | 5 | |
| | (P.B. 15:3) | | | | | |
| | Cyan pigment | | 5 | | | 5 |
| | (P.B. 15:4) | | | | | |
| | Magenta pigment | | | 5 | | |
| | (P.R. 122) | | | | | |
| | Glycerin | 8 | 8 | 8 | 8 | 8 |
| | Triethylene glycol | 3 | 3 | 3 | 3 | 3 |
| | monobutyl ether | | | | | |
| | 2-Pyrrolidone | 2 | 2 | | 1 | |
| | 1-(2-Hydroxyethyl)- | | | 1 | 7 | 1 |
| | 2-pyrrolidone | | | | | |
| | 1-(2-Hydroxypropyl)- | | | | | |
| | 2-pyrrolidone | | | | | |
| | Triethanolamine | 2 | 0.2 | | 0.2 | 3 |
| | Trimethylglycine | 2 | 6 | 6 | 0 | 1 |
| | Olfine E1010 | 1 | 1 | 1 | 1 | 2 |
| | Water | 77 | 74.8 | 76 | 74.8 | 77 |
| Number of | After leaving to stand at | 35 | 40 | 31 | 238 | 25 |
| nozzles | 40° C. for 1 day and | | | | | |
| with nozzle | cleaning once | | | | | |
| omission | After leaving to stand at | 352 | 263 | 248 | 436 | 275 |
| (total | 40° C. for 7 days and | | | | | |
| number of | cleaning once | | | | | |
| nozzles: | After leaving to stand at | 632 | 683 | 580 | 596 | 463 |
| 800) | 40° C. for 14 days and | | | | | |
| | cleaning once | | | | | |
| Number of | After leaving to stand at | 1 | 3 | 0 | 5 | 2 |
| nozzles | 40° C. for 1 day and | | | | | |
| with nozzle | cleaning 20 times | | | | | |
| omission | After leaving to stand at | 6 | 9 | 0 | 26 | 7 |
| after | 40° C. for 7 days and | | | | | |
| cleaning | cleaning 20 times | | | | | |
| 20 times | After leaving to stand at | 24 | 32 | 2 | 32 | 21 |
| | 40° C. for 14 days and | | | | | |
| | cleaning 20 times | | | | | |

The explanation is supplemented for each component shown in Table 2.

### Pigment

Carbon black

Cyan pigment (P.B.15:3): C.I. Pigment Blue 15:3, copper phthalocyanine blue, stabilized type (β)

Cyan pigment (P.B.15:4): C.I. Pigment Blue 15:4, copper phthalocyanine blue, stabilized type (β)

Magenta pigment (P.R.122): C.I. Pigment Red 122, quinacridone red

### Humectant

Glycerin

2-Pyrrolidone

### Penetrant

Triethylene glycol monobutyl ether

1-(2-Hydroxyalkyl)-2-pyrrolidone

1-(2-Hydroxyethyl)-2-pyrrolidone

1-(2-Hydroxypropyl)-2-pyrrolidone

### Organic Amine

Triethanolamine: manufactured by Tokyo Chemical Industry Co., Ltd.

### Surfactant

Olfine E1010: trade name, manufactured by Nissin Chemical Co., Ltd., acetylene glycol

The evaluation results above show that in Examples 1 to 7, the occurred nozzle omission could be recovered by performing cleaning 20 times and occurrence of permanent nozzle omission could be prevented. Incidentally, it is demonstrated from the evaluation results of Examples 1 to 7 that nozzle omission is more likely to occur when a cyan pigment is used as the pigment, compared to when other pigments are used. The reason thereof is inferred that since P.B.15:3 and P.B.15:4 are highly stable β-type crystals, when they are dry-solidified once and form solid contents, it is difficult to be re-dispersed.

In contrast, in Comparative Examples 1 to 6 not having a quantity ratio relationship of specific components, nozzle omission was likely to occur compared to Examples, and occurrence of permanent nozzle omission was observed.

The above-described embodiments and modifications are merely examples, and the present disclosure is not limited thereto. For example, it is possible to appropriately combine each embodiment and each modification.

The present disclosure includes configurations that are substantially the same as those described in the embodiments, for example, a configuration having the same function, method, and result or a configuration having the same purpose and effect. In addition, the present disclosure includes configurations in which non-essential parts of the configurations described in the embodiments are replaced. In addition, the present disclosure includes configurations that have the same effects or achieve the same purposes as those of the configurations described in the embodiments. Furthermore, the present disclosure includes configurations in which known techniques added to the configurations described in the embodiments.

The following contents are derived from the above-described embodiments and modifications.

An aspect of the aqueous ink jet composition includes:

a dye component composed of at least one of sublimation dyes and disperse dyes, polyester,

1-(hydroxyalkyl)-2-pyrrolidone, and

water, wherein

the content (mass %) of the polyester is 4.0 times or more and 300.0 times or less the content (mass %) of the dye component.

According to this aqueous ink jet composition, since 1-(hydroxyalkyl)-2-pyrrolidone is contained, the clogging recovery is excellent. In addition, according to this aqueous ink jet composition, since the content (mass %) of the polyester is 4.0 times or more and 300.0 times or less the content (mass %) of the dye component, it is possible to perform printing with a good color development property.

In the aqueous ink jet composition of the aspect above,

the content of the polyester may be 5.0 mass % or more and 30.0 mass % or less based on the total mass of the composition.

According to this aqueous ink jet composition, printing with a better color development property can be performed.

In the aqueous ink jet composition of the aspect above,

the content of the 1-(hydroxyalkyl)-2-pyrrolidone may be 1.0 mass % or more and 4.0 mass % or less based on the total mass of the composition.

According to this aqueous ink jet composition, printing with further good clogging recovery and color development property can be performed.

In the aqueous ink jet composition of the aspect above,

the content of the dye component may be 0.1 mass % or more and 7.5 mass % or less based on the total mass of the composition.

According to this aqueous ink jet composition, printing with a more sufficient color development property and recording with further good clogging recovery can be performed.

In the aqueous ink jet composition of the aspect above,

the content of the dye component may be 0.1 mass % or more and 3.0 mass % or less based on the total mass of the composition.

According to this aqueous ink jet composition, printing with a more sufficient color development property and recording with further good clogging recovery can be performed.

In the aqueous ink jet composition of the aspect above,

the polyester may be a polyester particle, and

the polyester particle may have an volume average particle diameter of 20.0 nm or more and 300.0 nm or less.

This aqueous ink jet composition has further good storage stability.

An aspect of the method for manufacturing a recorded matter includes:

an imparting step of discharging the aqueous ink jet composition of any of the above-described aspects by an ink jet method to impart it to a recording medium; and

a heating step of heating the recording medium imparted with the aqueous ink jet composition.

According to this method for manufacturing a recorded matter, a recorded matter can be manufactured with good clogging recovery, and the recorded matter can also have a good color development property.

An aspect of the aqueous ink jet ink composition is:

an aqueous ink jet ink composition containing a pigment, 1-(2-hydroxyalkyl)-2-pyrrolidone, trimethylglycine, and an organic amine, wherein

the pigment, the 1-(2-hydroxyalkyl)-2-pyrrolidone, and the trimethylglycine in the aqueous ink jet ink composition have a relationship of M_{B}≤M_{A}≤M_{C},

where M_{A} is the content (mass %) of the pigment, M_{B} is the content (mass %) of the 1-(2-hydroxyalkyl)-2-pyrrolidone, and M_{C} is the content (mass %) of the trimethylglycine.

In an aspect of the aqueous ink jet ink composition, the pigment may be a phthalocyanine pigment.

In any of the aspects of the aqueous ink jet ink composition,

the pigment may be at least one of C.I. Pigment Blue 15:3 and C.I. Pigment Blue 15:4.

In any of the aspects of the aqueous ink jet ink composition,

the content M_{A} of the pigment may be 3 mass % or more and 8 mass % or less.

In any of the aspects of the aqueous ink jet ink composition,

the content M_{B} of the 1-(2-hydroxyalkyl)-2-pyrrolidone may be 1 mass % or more and 5 mass % or less.

In any of the aspects of the aqueous ink jet ink composition,

the content M_{C} of the trimethylglycine may be 5 mass % or more.

In any of the aspects of the aqueous ink jet ink composition,

the organic amine may be at least one of triethanolamine and tripropanolamine.

In any of the aspects of the aqueous ink jet ink composition,

the organic amine in the aqueous ink jet ink composition may have a relationship of M_{D}≤M_{B}, where M_{D} is the content (mass %) of the organic amine.

An aspect of the ink set includes:

a first ink and a second ink different from the first ink in color, wherein

the first ink and the second ink each contain a pigment, 1-(2-hydroxyalkyl)-2-pyrrolidone, trimethylglycine, and an organic amine, and

the pigment, the 1-(2-hydroxyalkyl)-2-pyrrolidone, and the trimethylglycine in each of the first ink and the second ink have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine.

In an aspect of the ink jet recording apparatus,

two or more inks sealed with a single cap each contain a pigment, 1-(2-hydroxyalkyl)-2-pyrrolidone, trimethylglycine, and an organic amine, and

the pigment, the 1-(2-hydroxyalkyl)-2-pyrrolidone, and the trimethylglycine in each of the two or more inks have a relationship of M_{B}≤M_{A}≤M_{C}, where M_{A} is the content (mass %) of the pigment, M_{B} is the content (mass %) of the 1-(2-hydroxyalkyl)-2-pyrrolidone, and M_{C} is the content (mass %) of the trimethylglycine.

What is claimed is:

1. An aqueous ink jet composition comprising:
a dye component composed of at least one of sublimation dyes and disperse dyes;
polyester;
1-(hydroxyalkyl)-2-pyrrolidone; and
water, wherein
a content (mass %) of the polyester is 4.0 times or more and 300.0 times or less a content (mass %) of the dye component.

2. The aqueous ink jet composition according to claim 1, wherein
the content of the polyester is 5.0 mass % or more and 30.0 mass % or less based on the total mass of the composition.

3. The aqueous ink jet composition according to claim 1, wherein
a content of the 1-(hydroxyalkyl)-2-pyrrolidone is 1.0 mass % or more and 4.0 mass % or less based on the total mass of the composition.

4. The aqueous ink jet composition according to claim 1, wherein
the content of the dye component is 0.1 mass % or more and 7.5 mass % or less based on the total mass of the composition.

5. The aqueous ink jet composition according to claim 1, wherein
the content of the dye component is 0.1 mass % or more and 3.0 mass % or less based on the total mass of the composition.

6. The aqueous ink jet composition according to claim 1, wherein
the polyester is a polyester particle; and
the polyester particle has a volume average particle diameter of 20.0 nm or more and 300.0 nm or less.

7. A method for manufacturing a recorded matter, comprising:
an imparting step of discharging the aqueous ink jet composition according to claim 1 by an ink jet method to impart the composition to a recording medium; and
a heating step of heating the recording medium imparted with the aqueous ink jet composition.

8. An aqueous ink jet ink composition comprising:
a pigment;
1-(2-hydroxyalkyl)-2-pyrrolidone;
trimethylglycine; and
an organic amine, wherein
the pigment, the 1-(2-hydroxyalkyl)-2-pyrrolidone, and the trimethylglycine in the aqueous ink jet ink composition have a relationship of M_{B}≤M_{A}≤M_{C},
where M_{A} is a content (mass %) of the pigment, M_{B} is a content (mass %) of the 1-(2-hydroxyalkyl)-2-pyrrolidone, and M_{C} is a content (mass %) of the trimethylglycine.

9. The aqueous ink jet ink composition according to claim 8, wherein
the pigment is a phthalocyanine pigment.

10. The aqueous ink jet ink composition according to claim 8, wherein
the pigment is at least one of C.I. Pigment Blue 15:3 and C.I. Pigment Blue 15:4.

11. The aqueous ink jet ink composition according to claim 8, wherein
the content M_{A} of the pigment is 3 mass % or more and 8 mass % or less.

12. The aqueous ink jet ink composition according to claim 8, wherein
the content M_{B} of the 1-(2-hydroxyalkyl)-2-pyrrolidone is 1 mass % or more and 5 mass % or less.

13. The aqueous ink jet ink composition according to claim 8, wherein
the content M_{C} of the trimethylglycine is 5 mass % or more.

14. The aqueous ink jet ink composition according to claim 8, wherein
the organic amine is at least one of triethanolamine and tripropanolamine.

15. The aqueous ink jet ink composition according to claim 8, wherein
the organic amine in the aqueous ink jet ink composition has a relationship of M_{D}≤M_{B}, where M_{D} is a content (mass %) of the organic amine.

16. An ink set comprising:
a first ink and a second ink different from the first ink in color, wherein
the first ink and the second ink each contain a pigment, 1-(2-hydroxyalkyl)-2-pyrrolidone, trimethylglycine, and an organic amine, and
the pigment, the 1-(2-hydroxyalkyl)-2-pyrrolidone, and the trimethylglycine in each of the first ink and the second ink have a relationship of M_{B}≤M_{A}≤M_{C}, where M_{A} is a content (mass %) of the pigment, M_{B} is a content (mass %) of the 1-(2-hydroxyalkyl)-2-pyrrolidone, and M_{C} is a content (mass %) of the trimethylglycine.

17. An ink jet recording apparatus, wherein
a single head cap seals two or more inks each containing a pigment, 1-(2-hydroxyalkyl)-2-pyrrolidone, trimethylglycine, and an organic amine; and
the pigment, the 1-(2-hydroxyalkyl)-2-pyrrolidone, and the trimethylglycine in each of the two or more inks have a relationship of M_{B}≤M_{A}≤M_{C}, where M_{A} is a content (mass %) of the pigment, M_{B} is a content (mass %) of the 1-(2-hydroxyalkyl)-2-pyrrolidone, and M_{C} is a content (mass %) of the trimethylglycine.
